(19) United States
(12) Patent Application Publication
(10) Pub. No.: US 2018/0290740 A1
(43) Pub. Date: Oct. 11, 2018

(54) MONO-CYCLIC SWASHPLATE

(71) Applicant: Sikorsky Aircraft Corporation, Stratford, CT (US)

(72) Inventors: David A. Darrow, Jr., Stratford, CT (US); Ron William Waldo, North Richland Hills, TX (US); Stephen V. Poulin, Milford, CT (US); Bryan Kenneth Baskin, Arlington, TX (US); Biqiang Xu, Southlake, TX (US)

(21) Appl. No.: 15/570,911

(22) PCT Filed: Mar. 18, 2016
(86) PCT No.: PCT/US16/23151

§ 371 Date: Oct. 31, 2017

Related U.S. Application Data
(60) Provisional application No. 62/164,318, filed on May 20, 2015.

(51) Int. Cl. B64C 27/605; B64C 27/82; B64C 27/10

(52) U.S. Cl. CPC B64C 27/605; B64C 2027/8236; B64C 27/10; B64C 27/82

(57) ABSTRACT

An aircraft is provided and includes an airframe, a main rotor assembly operably disposed at an upper portion of the airframe to provide lift, a propulsor assembly operably disposed at a tail portion of the airframe to provide thrust and a control system. The control system includes a mono-cyclic swashplate assembly that is translatable in a translation direction to execute collective control of the propulsor assembly and rotatable about an axis defined transversely with respect to the translation direction to execute cyclic control of the propulsor assembly.

FEDERAL RESEARCH STATEMENT

This invention was made with Government support under Agreement No. W911W6-11-2-0007 for the Joint Multi-Role Demonstrator Configuration Trades and Analysis. The Government has certain rights in the invention.

### BACKGROUND

The subject matter disclosed herein relates to an aircraft control system and, more particularly, to an aircraft control system including a mono-cyclic swashplate.

A compound helicopter may include an airframe, a main rotor assembly and a propulsor assembly. The main rotor assembly is typically operably disposed at an upper portion of the airframe and may include coaxial, counter-rotating main rotors. The propulsor assembly could then be operably disposed at the tail portion of the airframe.

While compound helicopters have certain advantages, the propulsor assembly has only collective pitch control capability and often lacks cyclic control capability. Without such cyclic control, the propulsor assembly may not offer the required yaw control at low and medium forward speeds the aircraft might need to mitigate the effects of downwash from the main rotor assembly traveling through the propulsor assembly.

### BRIEF DESCRIPTION

According to one aspect, an aircraft is provided and includes an airframe, a main rotor assembly operably disposed at an upper portion of the airframe to provide lift, a propulsor assembly operably disposed at a tail portion of the airframe to provide thrust and a control system. The control system includes a mono-cyclic swashplate assembly that is translatable in a translation direction to execute collective control of the propulsor assembly and rotatable about an axis defined transversely with respect to the translation direction to execute cyclic control of the propulsor assembly.

In accordance with additional or alternative embodiments, the main rotor assembly includes coaxial, counter-rotating main rotors.

In accordance with additional or alternative embodiments, the translation direction is defined along a longitudinal axis of the tail portion.

In accordance with additional or alternative embodiments, the control system further includes a propulsor gearbox housing, a guide restricted to travel along the propulsor gearbox housing, the guide being pinned to the mono-cyclic swashplate assembly and actuators configured to apply torque to the mono-cyclic swashplate assembly.

In accordance with additional or alternative embodiments, the propulsor gearbox housing defines grooves and the guide includes a slider slidably disposed about the propulsor gearbox housing, pins extendable through the slider from the mono-cyclic swashplate assembly to the grooves and blocks disposed to secure respective ends of the pins within the grooves.

In accordance with additional or alternative embodiments, the pins and the grooves are disposed at opposite sides of the propulsor gearbox housing.

In accordance with additional or alternative embodiments, the actuators are disposed at opposite sides of the propulsor gearbox housing with 90° offsets from the pins and the grooves.

In accordance with additional or alternative embodiments, execution of the cyclic control is conducted at low and medium speed flight regimes.

According to another aspect, a controllable propulsor assembly is provided to generate thrust for and to provide for yaw control of an aircraft. The controllable propulsor assembly includes a propulsor gearbox housing, a mono-cyclic swashplate assembly that is translatable along the propulsor gearbox housing to execute collective propulsor control, a guide restricted to travel along the propulsor gearbox housing and actuators. The guide is pinned to the mono-cyclic swashplate assembly such that the mono-cyclic swashplate assembly is rotatable about the guide to execute cyclic propulsor control. The actuators are configured to apply torque to the mono-cyclic swashplate assembly to actuate translational and rotational control of the mono-cyclic swashplate assembly.

In accordance with additional or alternative embodiments, the mono-cyclic swashplate assembly is configured to transmit rotational blade pitch energy to a thrust generating propulsor from the propulsor gearbox housing.

In accordance with additional or alternative embodiments, the mono-cyclic swashplate assembly includes a stationary swashplate and a rotating swashplate that rotates about the stationary swashplate.

In accordance with additional or alternative embodiments, the propulsor gearbox housing defines grooves and the guide includes a slider slidably disposed about the propulsor gearbox housing, pins extendable through the slider from the stationary swashplate to the grooves and blocks disposed to secure respective ends of the pins within the grooves.

In accordance with additional or alternative embodiments, the pins and the grooves are disposed at opposite sides of the propulsor gearbox housing.

In accordance with additional or alternative embodiments, the actuators are disposed at opposite sides of the propulsor gearbox housing with 90° offsets from the pins and the grooves.

In accordance with additional or alternative embodiments, execution of the cyclic propulsor control is conducted at low and medium speed flight regimes.

These and other advantages and features will become more apparent from the following description taken in conjunction with the drawings.

### BRIEF DESCRIPTION OF THE DRAWINGS

The subject matter, which is regarded as the embodiments, is particularly pointed out and distinctly claimed in the claims at the conclusion of the specification. The foregoing and other features, and advantages are apparent from the following detailed description taken in conjunction with the accompanying drawings in which:

FIG. 1 is a side view of an aircraft in accordance with embodiments;

FIG. 2 is a perspective view of a propulsor swashplate assembly of the aircraft of FIG. 1;

FIG. 3 is an axial view of the propulsor swashplate assembly of FIG. 2; and

FIG. 4 is a side view of the propulsor swashplate assembly of FIG. 2.

The detailed description explains embodiments, together with advantages and features, by way of example with reference to the drawings.

### DETAILED DESCRIPTION

As will be described below, an aircraft is provided with a control system including a mono-cyclic design that gives the pilot yaw control at low and medium speeds and increases the flight envelope of the aircraft. This mono-cyclic design includes a guide that travels forward and aft on a propulsor gearbox housing and is pinned to a stationary swashplate with the two pins 180° apart. To anti-rotate the system, the two pins incorporate inboard blocks that slide in grooves in the gearbox housing as the guide moves in the collective region. This configuration provides collective through the sliding guide and one-directional cyclic through the pinned joint between the guide and the stationary swashplate.

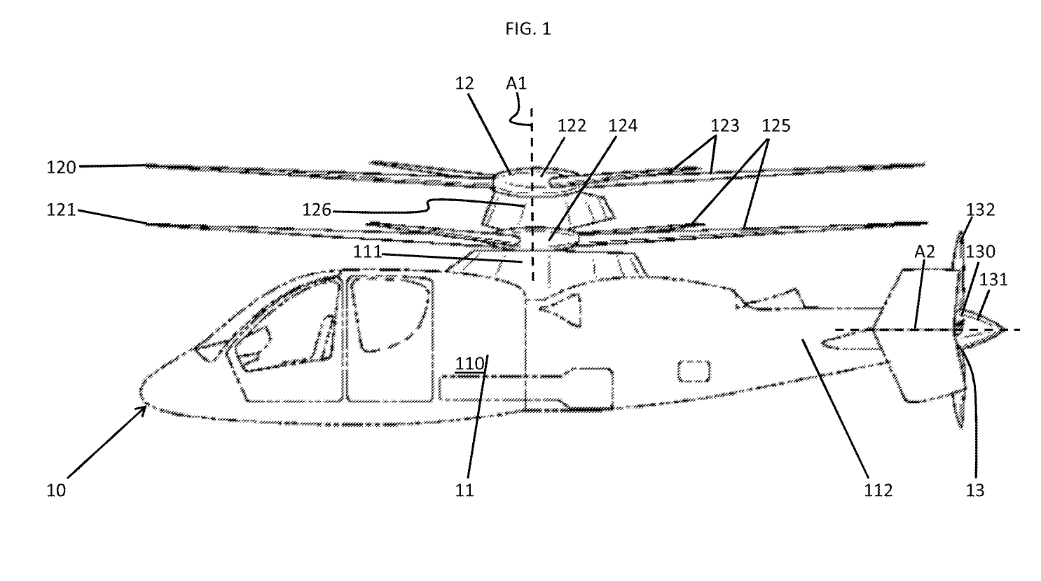

With reference to FIG. 1, an aircraft 10 is provided and may be configured in certain embodiments as a compound helicopter with coaxial, counter-rotating main rotors and a propulsor. The aircraft 10 includes an airframe 11, a main rotor assembly 12 and a propulsor assembly 13. The airframe 11 has a main portion 110, an upper portion 111 and a tail portion 112. The shown main portion 110 is configured to accommodate a pilot and, in some cases, cargo, and one or more crewmen and/or passengers, although it is understood that in an autonomous embodiment the pilot would be optional. The upper portion 111 is disposed above the main portion 110 and the tail portion 112 extends in the aft direction from the main portion 110. The main rotor assembly 12 is operably disposed at the upper portion 111 of the airframe 11. The propulsor assembly 13 is operably disposed at the tail portion 112 of the airframe 11.

The main rotor assembly 12 includes an upper rotor 120 and a lower rotor 121 that are each drivably rotatable in opposite rotational directions about a common rotational axis A1 defined through the airframe 11 to generate lift and thrust for the aircraft 10. The upper rotor 120 includes an upper hub 122 and upper rotor blades 123 extending outwardly from the upper hub 122. Similarly, the lower rotor 121 includes a lower hub 124 and lower rotor blades 125 extending outwardly from the lower hub 124. The main rotor assembly 12 may further include an aerodynamic fairing 126 interposed between the upper and lower hubs 122 and 124. Each of the upper rotor blades 123 and each of the lower rotor blades 125 can be pivoted about a respective longitudinal axis thereof by way of collective and cyclic commands to execute flight control (e.g., lift, pitch, roll and yaw control) of the aircraft 10.

The propulsor assembly 13 includes a propulsor 130 that is drivably rotatable about a propulsor rotational axis A2, which is shown substantially parallel with a longitudinal axis of the tail portion 112, to generate additional thrust for the aircraft 10. The propulsor 130 includes a hub 131 and rotor blades 132 extending outwardly from the hub 131. Each of the rotor blades 132 can be pivoted about a respective longitudinal axis thereof by way of collective and cyclic commands to execute additional flight control (e.g., thrust and yaw control) of the aircraft 10. For example, the rotor blades 132 can be controlled collectively in order to increase or decrease aircraft 10 thrust and at low and medium speed flight regimes, in particular, the rotor blades 132 can be controlled cyclically to provide for increased or decreased yaw control of the aircraft 10.

Although not shown, the aircraft 10 further includes an engine, a transmission system and a flight computer. The engine generates power by which the main rotor assembly 12 and the propulsor assembly 13 are operated and the transmission system transmits the generated power from the engine to the main rotor assembly 12 and the propulsor assembly 13. The flight computer controls various operations of the engine, the transmission system and the collective and cyclic controls of the main rotor assembly 12 and the propulsor assembly 13 in accordance with pilot inputted commands, control algorithms and current flight conditions.

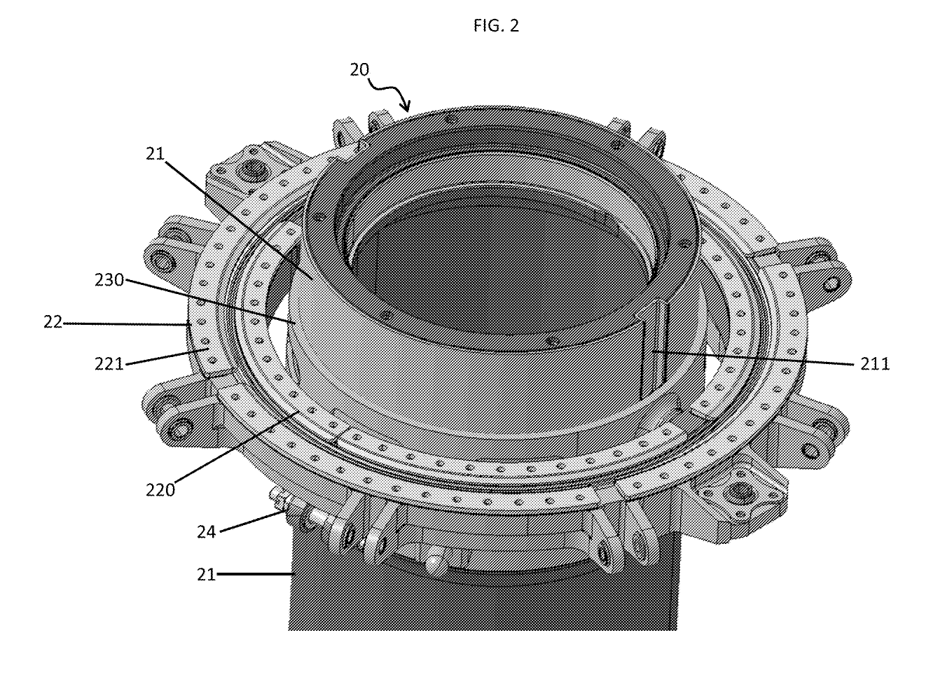

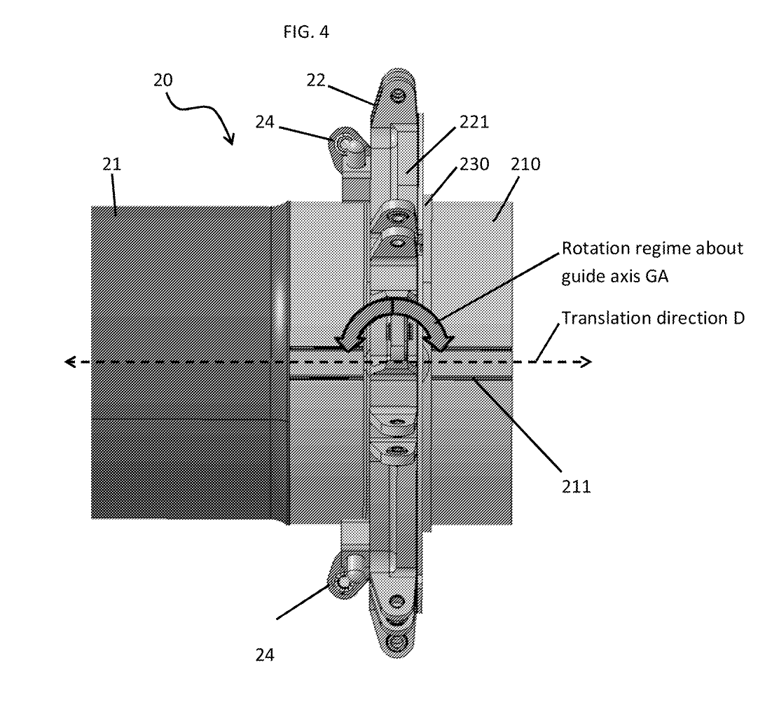

With reference to FIGS. 2-4, a control system 20 is provided to control the propulsor assembly 13 such that the propulsor assembly 13 generates thrust for the aircraft 10 and such that the propulsor assembly provides for yaw control of the aircraft 10 particularly at low and medium flight speed regimes.

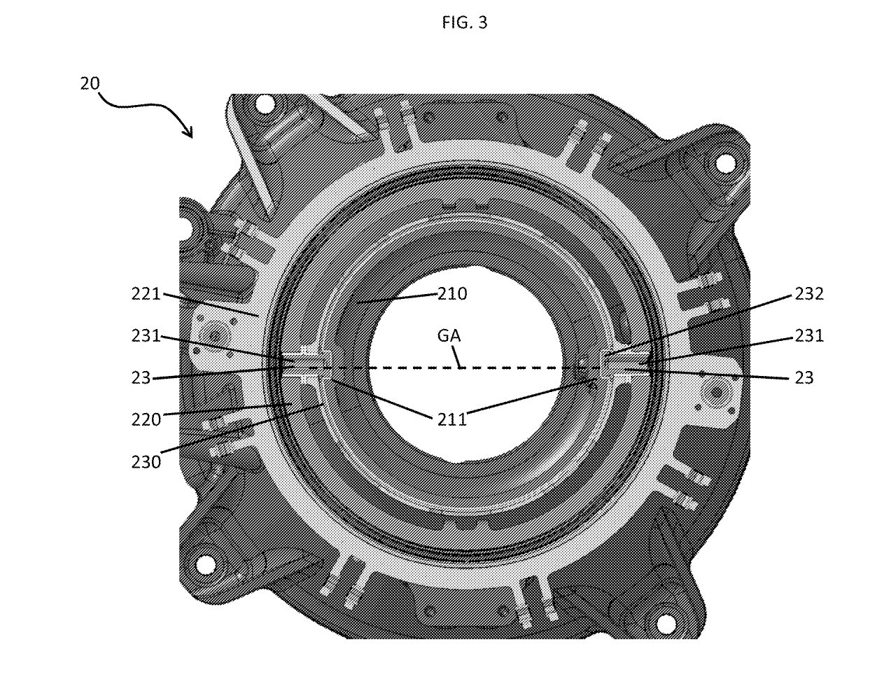

The control system 20 includes a propulsor gearbox housing 21, which may be a component of the above-described transmission system, a mono-cyclic swashplate assembly 22, a guide 23 (see FIG. 3) and actuators 24. The control system 20 is disposed and configured such that the mono-cyclic swashplate assembly 22 is translatable in a translation direction D to thereby execute the collective control of the propulsor assembly 13. In accordance with embodiments, the translation direction D may be defined along a longitudinal axis of the tail portion 112 of the airframe 11 and/or the rotational axis A2 (see FIG. 1). The control system 20 is further disposed and configured such that the mono-cyclic swashplate assembly 22 is rotatable about a guide axis GA that is defined transversely with respect to the translation direction D to thereby execute the cyclic control of the propulsor assembly 13.

The propulsor gearbox housing 21 may be provided as a tubular element 210 that is extendable along the propulsor rotational axis A2 (see FIG. 1). The tubular element 210 has an exterior surface that is formed to define grooves 211. The grooves 211 may be aligned with the propulsor rotational axis A2 and, in some cases, may be defined as two grooves 211 on the opposite sides of the tubular element 210 with 180° separation. For purposes of clarity and brevity, this embodiment will be described herein although it is to be understood that other formations including lesser or greater number of grooves 211 with differing angular positions are possible.

The mono-cyclic swashplate assembly 22 is configured to transmit rotational blade pitch energy to the propulsor 130 from the propulsor gearbox housing 21 and includes a stationary swashplate 220 and a rotating swashplate 221. The rotating swashplate 221 includes an annular element that is driven by way of lugs coupled to its exterior surface. The rotating swashplate 221 drives the pitch rotations of the propulsor rotor blades 132 by way of other lugs coupled to its exterior surface. The rotating swashplate 221 is disposed about the stationary swashplate 220 and is supported in that position by way of bearing elements interposed between an exterior surface of the stationary swashplate 220 and an interior surface of the rotating swashplate 221. The stationary swashplate 220 includes an annular element as well and is disposed about the propulsor gearbox housing 21. With this configuration, the mono-cyclic swashplate assembly 22 as a whole is translatable in the translation direction D along the propulsor gearbox housing 21 to execute the collective control of the propulsor assembly 13.

The guide 23 is restricted to travel in the translation direction D along the propulsor gearbox housing 21 and is pinned to the stationary swashplate 220 of the mono-cyclic swashplate assembly 22 such that the mono-cyclic swashplate assembly 22 is rotatable about the guide 23 to execute the cyclic control of the propulsor assembly 13. The guide 23 includes a slider 230, pins 231 and blocks 232. The slider 230 is provided as an annular element that is fittable about the tubular element 210 of the propulsor gearbox housing 21 and slidable along the exterior surface thereof in the translation direction D. The pins 231 may be provided as two pins 231 with 180° separation that define the guide axis GA and are extendable through the slider 230 from an interior portion of the stationary swashplate 220 to the grooves 211 on the opposite sides of the propulsor gearbox housing 21. The blocks 232 are coupled to respective interior ends of the pins 231 and are thus disposable to secure the respective interior ends of the pins 231 within the grooves 211. The pins 231 can be separate from the blocks 232, or can be a thin member extending from the swashplate 220 into the groove 211.

The actuators 24 are configured to apply torque to the mono-cyclic swashplate assembly 22. The actuators 24 may be tied and/or controlled by way of the propulsor gearbox housing 21 and, in some exemplary embodiments, may be provided as two actuators 24 disposed at opposite sides of the propulsor gearbox housing 21 with 90° offsets from the respective pairs of the pins 231 and the grooves 211. With this configuration, respective magnitudes of the torque provided by the actuators 24 may be set to actuate translational and rotational control of the mono-cyclic swashplate assembly 22.

That is, the two actuators 24 can each apply force to the mono-cyclic swashplate assembly 22 with a same positive magnitude to cause the mono-cyclic swashplate assembly 22 to translate in the positive (i.e., aft) translation direction D along the propulsor gearbox housing 21. Such action actuates the collective control of the propulsor assembly 13 to increase a collective pitch of the rotor blades 132 and to thereby increase a thrust of the aircraft 10. Conversely, the two actuators 24 can each apply force to the mono-cyclic swashplate assembly 22 with a same negative magnitude to cause the mono-cyclic swashplate assembly 22 to translate in the negative (i.e., forward) translation direction D along the propulsor gearbox housing 21. Such action similarly actuates the collective control of the propulsor assembly 13 to decrease a collective pitch of the rotor blades 132 and to thereby decrease a thrust of the aircraft 10.

The two actuators 24 can also apply differential torque to the mono-cyclic swashplate assembly 22 to cause the mono-cyclic swashplate assembly 22 to rotate about axis GA using the pins 231 in the positive or negative directions about the axis A. Such action actuates the cyclic control of the propulsor assembly 13 to increase or decrease cyclic pitch of the rotor blades 132 and to thereby provide for the yaw control of the aircraft 10 especially at low and medium speed flight regimes.

Although the collective and cyclic controls were described separately, it is to be understood that they can be applied separately or simultaneously. That is, the two actuators 24 can apply torque to the mono-cyclic swashplate assembly of slightly different positive magnitude to thereby increase thrust of the aircraft 10 and to provide for yaw control at the same time. Conversely, the two actuators 24 can apply torque to the mono-cyclic swashplate assembly of slightly different negative magnitude to thereby decrease thrust of the aircraft 10 and to again provide for yaw control at the same time.

While the embodiments have been described, it should be readily understood that the aspects are not limited to such disclosures. Rather, the embodiments can be modified to incorporate any number of variations, alterations, substitutions or equivalent arrangements not heretofore described, but which are commensurate with the spirit and scope of the description. Additionally, while various embodiments have been described, it is to be understood that aspects may include only some of the described embodiments. Accordingly, the description is not to be seen as so limited.

What is claimed is:

1. An aircraft, comprising:
an airframe;
a main rotor assembly operably disposed at an upper portion of the airframe to provide lift;
a propulsor assembly operably disposed at a tail portion of the airframe to provide thrust; and
a control system comprising a mono-cyclic swashplate assembly that is translatable in a translation direction to execute collective control of the propulsor assembly and rotatable about an axis defined transversely with respect to the translation direction to execute cyclic control of the propulsor assembly.

2. The aircraft according to claim 1, wherein the main rotor assembly comprises coaxial, counter-rotating main rotors.

3. The aircraft according to claim 1, wherein the translation direction is defined along a longitudinal axis of the tail portion.

4. The aircraft according to claim 1, wherein the control system further comprises:
a propulsor gearbox housing;
a guide restricted to travel along the propulsor gearbox housing, the guide being pinned to the mono-cyclic swashplate assembly; and
actuators configured to apply torque to the mono-cyclic swashplate assembly.

5. The aircraft according to claim 4, wherein the propulsor gearbox housing defines grooves and the guide comprises:
a slider slidably disposed about the propulsor gearbox housing;
pins extendable through the slider from the mono-cyclic swashplate assembly to the grooves; and
blocks disposed to secure respective ends of the pins within the grooves.

6. The aircraft according to claim 5, wherein the pins and the grooves are disposed at opposite sides of the propulsor gearbox housing.

7. The aircraft according to claim 6, wherein the actuators are disposed at opposite sides of the propulsor gearbox housing with 90° offsets from the pins and the grooves.

8. The aircraft according to claim 1, wherein execution of the cyclic control is conducted at low and medium speed flight regimes.

9. A controllable propulsor assembly to generate thrust for and to provide for yaw control of an aircraft, the propulsor assembly comprising:
a propulsor gearbox housing;
a mono-cyclic swashplate assembly that is translatable along the propulsor gearbox housing to execute collective propulsor control;
a guide restricted to travel along the propulsor gearbox housing, the guide being pinned to the mono-cyclic swashplate assembly such that the mono-cyclic swashplate assembly is rotatable about the guide to execute cyclic propulsor control; and
actuators configured to apply torque to the mono-cyclic swashplate assembly to actuate translational and rotational control of the mono-cyclic swashplate assembly.

10. The controllable propulsor assembly according to claim 9, wherein the mono-cyclic swashplate assembly is configured to transmit rotational blade pitch energy to a thrust generating propulsor from the propulsor gearbox housing.

11. The controllable propulsor assembly according to claim 9, wherein the mono-cyclic swashplate assembly comprises:
a stationary swashplate; and
a rotating swashplate that rotates about the stationary swashplate.

12. The controllable propulsor assembly according to claim 11, wherein the propulsor gearbox housing defines grooves and the guide comprises:
a slider slidably disposed about the propulsor gearbox housing;
pins extendable through the slider from the mono-cyclic swashplate assembly to the grooves; and
blocks disposed to secure respective ends of the pins within the grooves.

13. The controllable propulsor assembly according to claim 12, wherein the pins and the grooves are disposed at opposite sides of the propulsor gearbox housing.

14. The controllable propulsor assembly according to claim 13, wherein the actuators are disposed at opposite sides of the propulsor gearbox housing with 90° offsets from the pins and the grooves.

15. The controllable propulsor assembly according to claim 9, wherein execution of the cyclic propulsor control is conducted at low and medium speed flight regimes.
